(19) United States
(12) Patent Application Publication
(10) Pub. No.: US 2007/0159049 A1
(43) Pub. Date: Jul. 12, 2007

(54) Method and system of rendering particle

(75) Inventors: Do Kyoon Kim, Yongin-si (KR); Kee Chang Lee, Yongin-si (KR); Se Yoon Tak, Yongin-si (KR); Sang Oak Woo, Yongin-si (KR); Jeong Hwan Ahn, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/652,051

(22) Filed: Jan. 11, 2007

(30) Foreign Application Priority Data
Jan. 11, 2006 (KR) 2006-3045

(51) Int. Cl. H01J 29/10

(52) U.S. Cl. 313/461

(57) ABSTRACT

A particle rendering method and system that can receive a selection of a shape and/or a motion of a particle or a selection or a correction of a predetermined particle pattern, and generate a particle corresponding to the selection thereby generating a particle that has the desired shape and motion. Furthermore, the method and system can render a large number of particles in real time by sorting a plurality of particles using a render group. The particle rendering system includes a receiving module to receive a selection on a shape or a motion of a particle, and a first particle generation unit to generate a first particle corresponding to the shape or the motion by calling information corresponding to the shape selection from a shape information module or information corresponding to the motion selection from a motion information module.

### CROSS-REFERENCE TO RELATED APPLICATION

This application claims the benefit of Korean Patent Application No. 2006-3045, filed on Jan. 11, 2006 in the Korean Intellectual Property Office, the disclosure of which is incorporated herein by reference.

### BACKGROUND OF THE INVENTION

1. Field of the Invention

Aspects of the present invention relate to a particle rendering method and system, and more particularly, to a particle rendering method and system that can receive a selection on a shape and/or a motion of a particle or a selection or a correction of a predetermined particle pattern, from a user, and generate a particle corresponding to the selection, thereby generating a particle that has the user's desired shape and/or motion. Aspects of the present invention can also render a large number of particles in real time by sorting a plurality of particles using a render group.

2. Description of the Related Art

With developments of computing technologies, methods of rendering to more realistically produce an image are being developed. Rendering is a process that takes into consideration a shadow, a color, a depth, etc., that change according to external information such as a shape of an image, a location thereof, and lighting, to make a more realistic image. Namely, rendering is a computer graphic process of changing the shadow or the depth of the two-dimensional object, thereby giving a three-dimensional effect to a two-dimensional object and making the object more realistic.

Conventionally, a method of expressing a particle in an image is utilized as a rendering method. FIG. 1 is a diagram illustrating an example of a particle included in an image according to a conventional art. Referring to FIG. 1, a particle rendering system renders a plurality of particles 101 so as to express a certain portion of an animation image.

In this instance, the plurality of particles 101 may be points, sprites and geometries that can be expressed by various types and colors. Also, the plurality of particles 101 may be rendered to thereby express smoke, a waterfall, dust, etc.

FIG. 2 is a diagram illustrating an example of generating a particle according to the conventional art. Referring to FIG. 2, in the conventional art, one particle is defined and generated in one data structure, for example, data structures 201, 202 and 203. As an example, generation of a smoke particle, and a motion and a shape of the smoke particle are defined in one data structure 201 so as to generate the smoke particle. Namely, according to the conventional art, a plurality of data structures 201, 202, and 203 must be defined to generate a plurality of particles. Moreover, particles are rarely either recycled or expanded.

Also, in the conventional art, the entire data structure 201, 202, and 203 must be changed so as to correct a portion of a particle. Namely, all of the data in the data structure 201 must be changed so as to correct the movement speed of a smoke particle. Accordingly, modification of a generated particle or correction of the generated particle is not simple.

In the conventional art, when each of the data structures 201, 202, and 203 is defined and a plurality of particles is generated as described above, a plurality of particles belonging to an identical type is stored as a particle set and rendered.

FIG. 3 is a diagram illustrating an example of rendering a plurality of particle sets according to the conventional art. When a first particle set 301, a second particle set 302, . . . , and an N^{th} particle set 303 that maintain a plurality of particles are stored, a particle rendering system according to the conventional art calls each particle set using a rendering stream link function, transfers each of the called particle sets to a graphics part 304, calls each of the transferred particle sets using a rendering function, and then renders.

Accordingly, the particle rendering system calls the rendering stream link function N number of times and calls the rendering function N number of times so as to render an N number of particle sets. Namely, since a function is called 2N number of times, a rendering speed is deteriorated.

Consequently, a particle rendering method and system that can outperform the conventional art, easily define and generate a particle as a user desires, and improve a rendering speed by reducing a number of times that a function is called to render particles, thereby embodying real-time rendering, is needed.

### SUMMARY OF THE INVENTION

Aspects of the present invention provide a particle rendering method and system in which a user can easily generate a desired particle by only selecting shape information and/or motion information that are pre-generated and maintained. Aspects of the present invention also provide a particle rendering method and system in which a user can easily correct and change a shape and/or a motion of a predetermined particle pattern and then render the predetermined particle. Aspects of the present invention also provide a particle rendering method and system that can render even a large number of particles in real time by sorting particles having a similar property into render groups and rendering particles for each render group. Furthermore, aspects of the present invention provide a particle rendering method and system that can render even a large number of particles in real time and improve a rendering speed by significantly reducing a number of times that a function is called to render particles.

According to an aspect of the present invention, there is provided a particle rendering system including: a receiving module to receive a selection of a shape and/or a motion of a particle; and a first particle generation unit to generate a first particle corresponding to the shape and/or the motion by calling information corresponding to the shape selection from a shape information module and/or information corresponding to the motion selection from a motion information module.

According to another aspect of the present invention, there is provided a particle rendering method including: receiving a selection of a shape and/or a motion of a particle from a user; and generating a first particle corresponding to the shape and/or the motion by calling information corresponding to the shape selection from a shape information module and/or information corresponding to the motion selection from a motion information module.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an example of a particle included in an image according to a conventional art;

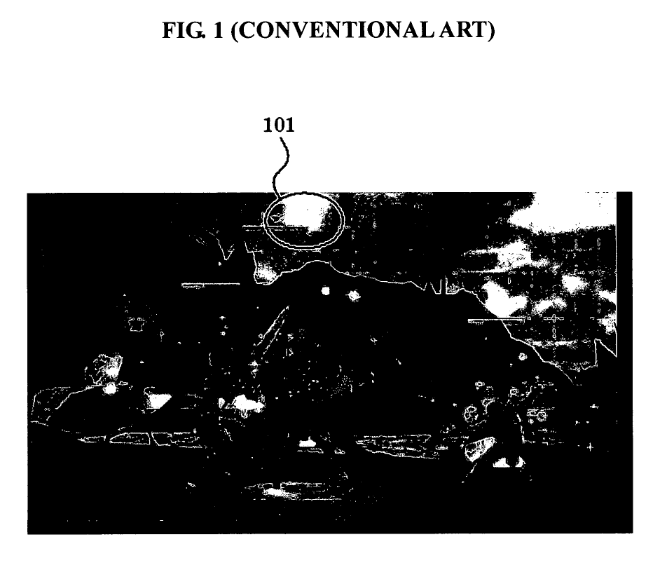

FIG. 2 is a diagram illustrating an example of generating a particle according to the conventional art;

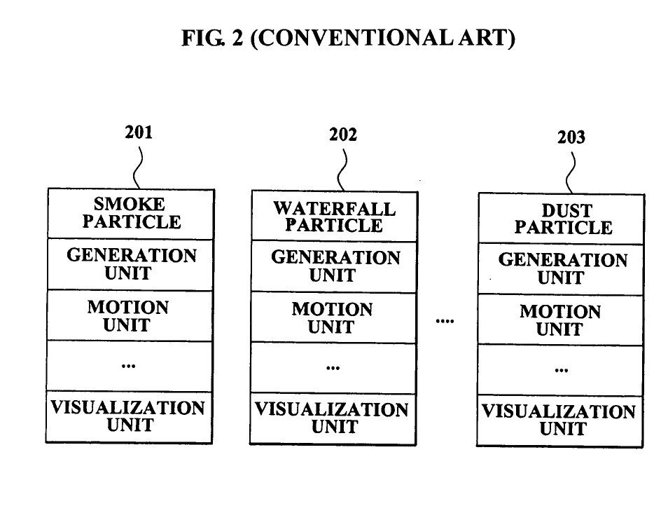

FIG. 3 is a diagram illustrating an example of rendering a plurality of particle sets according to the conventional art;

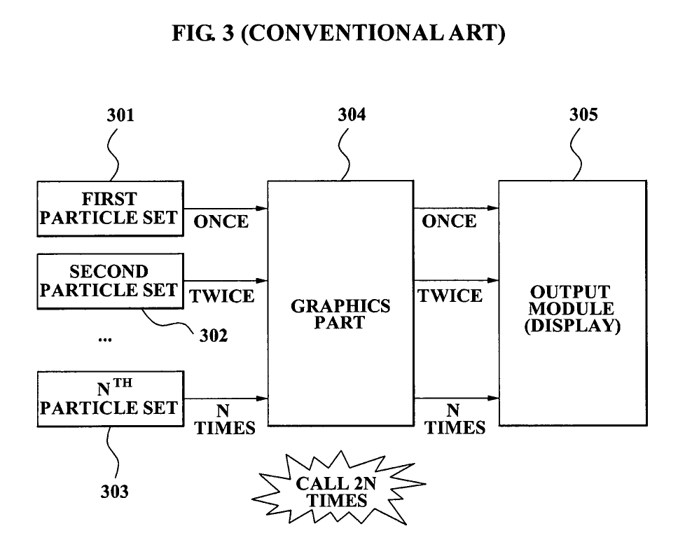

FIG. 4 is a flowchart illustrating a process of rendering a particle according to an embodiment of the present invention;

FIG. 5 is a diagram illustrating a configuration of generating a particle according to an embodiment of the present invention;

FIG. 6 is a diagram illustrating a process of generating a particle in a particle rendering system according to an embodiment of the present invention;

FIG. 7 is a diagram illustrating an example of sorting a plurality of particle sets and generating a render group according to an embodiment of the present invention;

FIG. 8 is a diagram illustrating an example of a generated render group by sorting a plurality of particle sets according to an embodiment of the present invention;

FIG. 9 is a diagram illustrating an example of a particle rendering system rendering a render group according to an embodiment of the present invention;

FIG. 10 is a diagram illustrating rendered particles according to an embodiment of the present invention; and

FIG. 11 is a block diagram illustrating a configuration of a particle rendering system according to an embodiment of the present invention.

### DETAILED DESCRIPTION OF THE EMBODIMENTS

Reference will now be made in detail to present embodiments of the present invention, examples of which are illustrated in the accompanying drawings, wherein like reference numerals refer to the like elements throughout. The embodiments are described below in order to explain the present invention by referring to the figures.

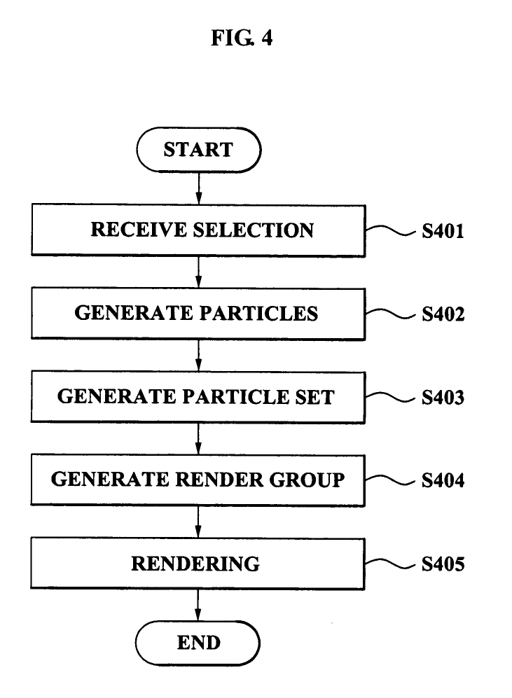

FIG. 4 is a flowchart illustrating a process of rendering a particle according to an embodiment of the present invention. In operation S401, a particle rendering system receives a selection on a shape or a motion of a particle from a user. In this instance, the shape selection of the particle may be a selection with respect to at least one of a type, a rotation angle, an external appearance, a color, and a transparency of the particle, but not limited thereto. Also, the motion selection may be a selection with respect to at least one of a duration time, a location, a speed, and an acceleration of the particle, but not limited thereto. As an example, a user may select and input a shape of a particle as a sprite, a color of the particle in red, and a speed of the particle as 3 cm/s. It is understood that reference to “at least one” is intended to refer to at least one of the listed items, and not at least one of each item. For example, at least one of x, y, and z refers to the sets: (x), (y), (z), (x,y), (x,z), (y,z), or (x,y,z).

In operation S402, the particle rendering system generates a first particle corresponding to the shape or the motion by calling information corresponding to the shape selection from a shape information module or information corresponding to the motion selection from a motion information module.

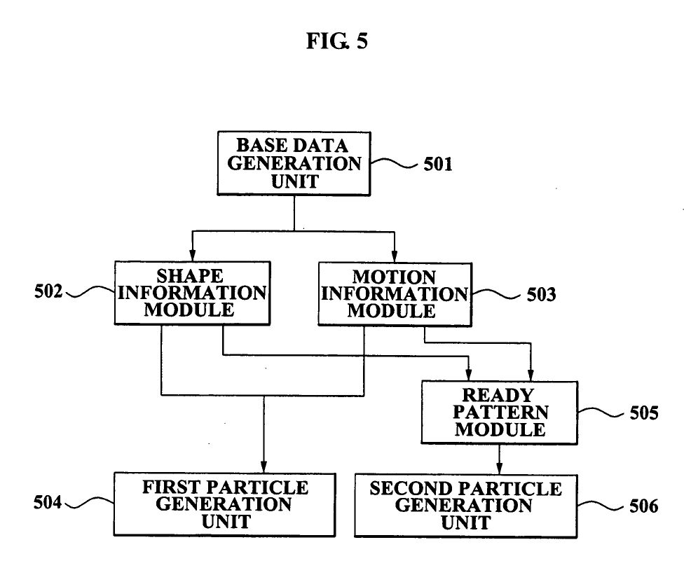

FIG. 5 is a diagram illustrating a configuration of generating a particle according to an embodiment of the present invention. Referring to FIG. 5, a first particle generation unit 504 initially calls basic information about generation of a particle, such as a duration time of a particle and location information (relating to the entire image), from a base data generation unit 501. The first particle generation unit 504 subsequently generates a first particle corresponding to the shape or the motion by calling information corresponding to the shape selection from a shape information module 502 and/or information corresponding to the motion selection from a motion information module 503.

The shape information module 502 stores information on at least one of a type, a rotation angle, an external appearance, a color, and a transparency of the particle, but not limited thereto. Also, the motion information module 503 stores information on at least one of a duration time, a location, a speed, and an acceleration of the particle, but not limited thereto. In this instance, the shape information or the motion information is an example of information to generate a data structure of a particle, and may be program information or code to generate a shape and/or a motion.

As an example, when a user selects a shape of a particle as a sprite, a color of the particle as red and a speed of the particle as 3 cm/s, the particle rendering system calls information on a red sprite from the shape information module 502 and calls information on the speed, 3 cm/s, from the motion information module 503, and generates a data structure corresponding to a first particle. As a result, according to aspects of the present invention, a particle according to a shape or a motion selected by a user may be easily rendered.

A user may also desire to designate and generate a shape and a motion of a desired particle in detail. Also, a user may desire to correct a generated particle pattern. Accordingly, the particle rendering system may include a ready pattern module 505 storing a plurality of predetermined particle pattern information so as to enable a user to easily correct a particle. In this instance, the particle pattern information includes information on a shape and a motion of a particle.

The particle rendering system may initially receive a selection of a particle pattern and a selection of a shape and/or a motion, from a user, and subsequently correct and render a shape or a motion of a particle corresponding to the selected particle pattern. In this instance, the particle rendering system calls particle pattern information corresponding to a particle pattern selection from the ready pattern module 505, shape information corresponding to the shape selection from the shape information module 502, and/or motion information corresponding to the motion selection from the motion information module 503. The particle rendering system then changes the shape information and/or motion information of the called particle pattern information into the called shape information and/or motion information, and generates a second particle.

As an example, a particle rendering system stores a smoke particle, a waterfall particle, a dust particle, etc., in the ready pattern module 505. In this instance, when the particle rendering system receives a selection of a “smoke particle,” which is a ready pattern, and also receives a selection of “purple color” from a user, the particle rendering system may correct a color of the smoke particle included in the ready pattern module 505 to be “purple” and generate a second particle.

According to aspects of the present invention, users may readily render a particle according to a pre-stored pattern or a newly made pattern as they desire. Namely, in the conventional art, a user had to define a shape and a motion of a particle in one data structure so as to generate one particle. However, in the present invention, a user may easily generate a desired particle by only selecting pre-generated and maintained shape information or motion information. Also, in the conventional art, a user had to utilize a predetermined particle pattern as it was. However, in the present invention, a user may easily correct and change a shape and a motion, even when a particle pattern is predetermined.

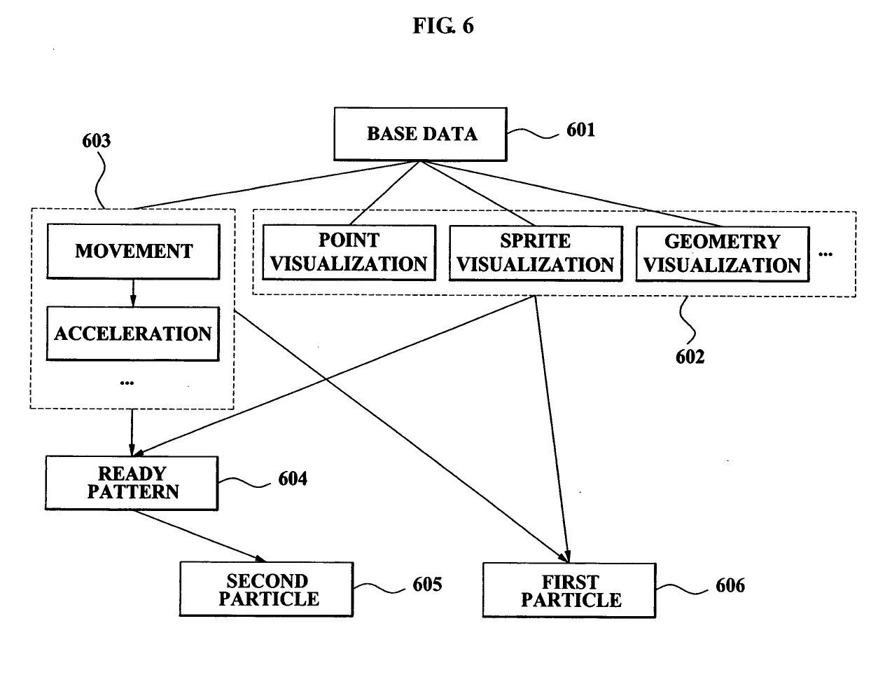

FIG. 6 is a diagram illustrating a process of generating a particle in a particle rendering system according to an embodiment of the present invention. Referring to FIG. 6, a user may generate a first particle 606 by selecting shape information 602 or motion information 603 and adding the selected shape information 602 or motion information 603 to a base data 601 of a particle. Also, the user may generate a second particle 605 by adding the shape information 602 or the motion information 603 to a particle of a ready pattern 604.

In operation S403 of FIG. 4, the particle rendering system stores the first particle 606 or the second particle 605 in a predetermined storage unit, and generates a particle set including a plurality of particles that are stored in the storage unit or the ready pattern module 505. In this instance, a particle set is an object collecting each generated particle and also a configuration of effectively rendering particles.

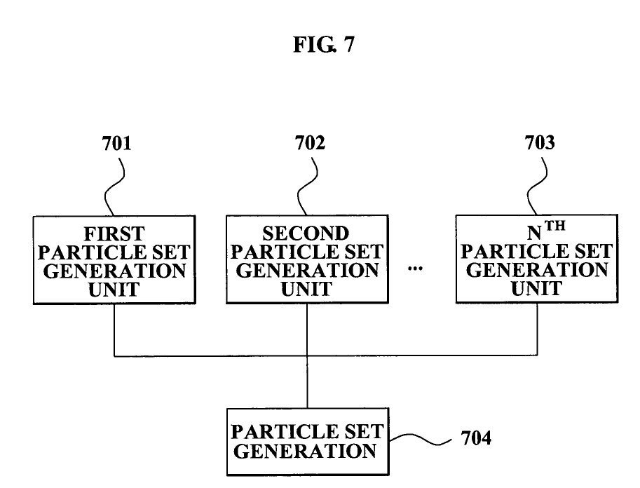

FIG. 7 is a diagram illustrating an example of sorting a plurality of particle sets and generating a render group according to an embodiment of the present invention. Referring to FIG. 7, a particle rendering system may collect particles 605 and 606 that are generated in each of the particle set generation units 701, 702 and 703, and generate a particle set 704.

In operation S404 of FIG. 4, the particle rendering system sorts a plurality of particle sets and generates a render group. In operation S405, the particle rendering system renders the generated render group. In this instance, the category by which the particle rendering system groups particle sets may be information on at least one information on a texture, an opacity, and a material of the particle, but not limited thereto.

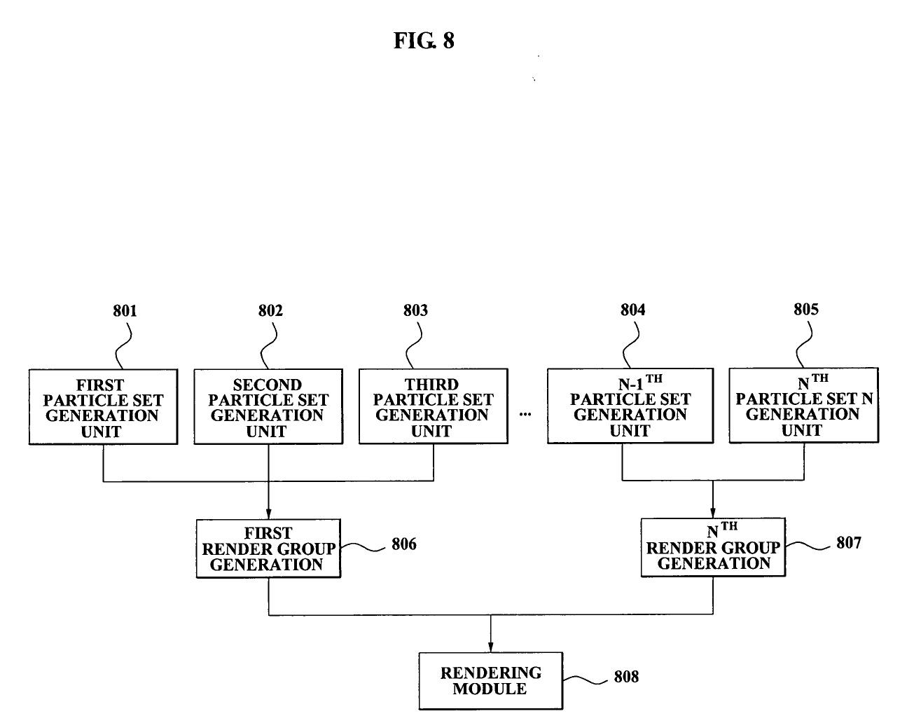

FIG. 8 is a diagram illustrating an example of a generated render group by sorting a particle set 704 according to an embodiment of the present invention. Referring to FIG. 8, the particle rendering system groups particle sets 704, which are sorted according to, for example, a texture, an opacity, and/or material information of each of the particles 605 and 606 collected in each particle set 704, as a render group and designates the same as one object. As an example, the particle rendering system designates a first particle set 801, a second particle set 802, and a third particle set 803, whose particles have similar opacity, as a first render group 806. Namely, the particle rendering system groups particles 605 and 606 having a similar property as a render group 806, and transfers the render group 806 to a rendering module 808. Accordingly, even a large number of particles 605 and 606 may be rendered in real time.

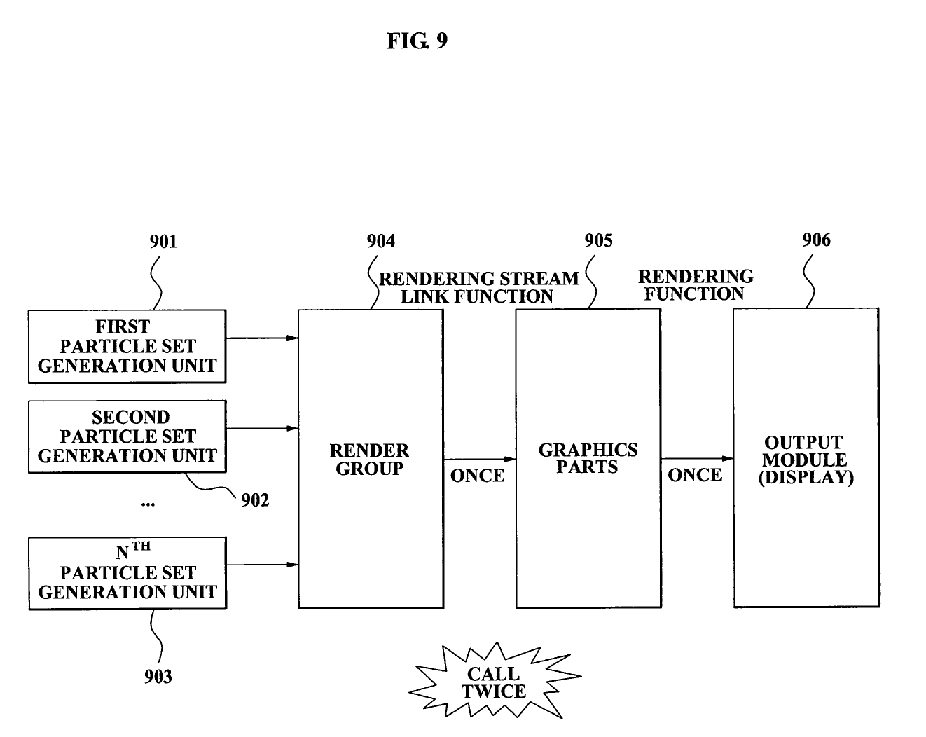

FIG. 9 is a diagram illustrating an example of a particle rendering system rendering a render group 806 according to an embodiment of the present invention. Referring to FIG. 9, the particle rendering system designates particle sets 801, 802, and 803 of a plurality of particle set generation units 901, 902, and 903 as a render group 904, and calls and renders particles 605 and 606 for each render group using a rendering module. According to an aspect of the present invention, the rendering module may include a graphics part 905 and an output module 906. Also, the rendering module is any system that renders a target object.

When a selection of a render group 904 is received, the particle rendering system calls a render group object using a rendering stream link function and transfers the called render group object to the graphics part 905. Then, the particle rendering system calls and outputs the render group object transferred to the graphics part 905 using a rendering function.

In this instance, the particle rendering system generates a mesh by sorting the particle set 801, 802, and 803 included in the render group 904 according to a distance order from a reference point, and renders the mesh by calling the render group. Namely, while a function must be called 2N number of times so as to render an N number of particle sets in the conventional art, a function needs to be called only twice so as to render the N number of particle sets. Accordingly, a number of times that a function for rendering is called is significantly reduced so that a rendering speed may be improved and real-time rendering becomes possible. In other words, according to aspects of the present invention, even thousands or tens of thousands of particles may be rendered in real time through a designation of a render group.

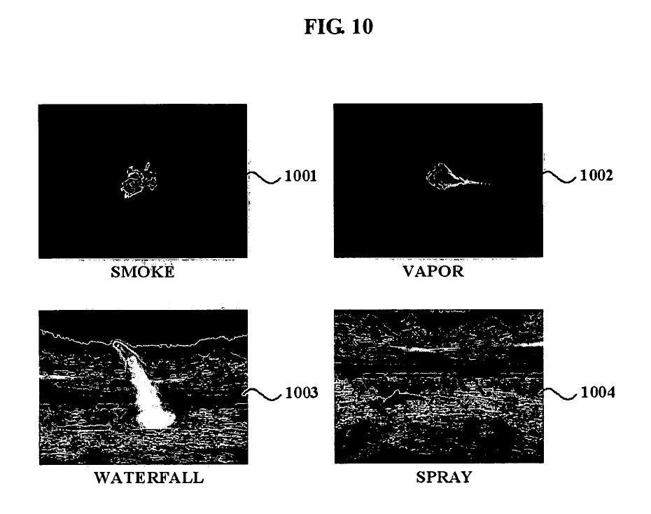

FIG. 10 is a diagram illustrating rendered particles according to an embodiment of the present invention. Referring to FIG. 10, the present invention may easily generate particles that show various effects, such as smoke 1001, vapor 1002, a waterfall 1003, and a spray 1004. Also, a plurality of generated particles 1001, 1002, 1003, and 1004 may be rendered in real time.

The particle rendering method according to the above-described aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a computer data signal embodied in a carrier wave comprising a compression source code segment and an encryption source code segment (such as data transmission through the Internet), data structures, etc. Examples of program instructions include both machine code, such as produced by a compiler, and files containing higher level code that may be executed by the computer using an interpreter. The described hardware devices may be configured to act as one or more software modules in order to perform the operations of the above-described aspects of the present invention.

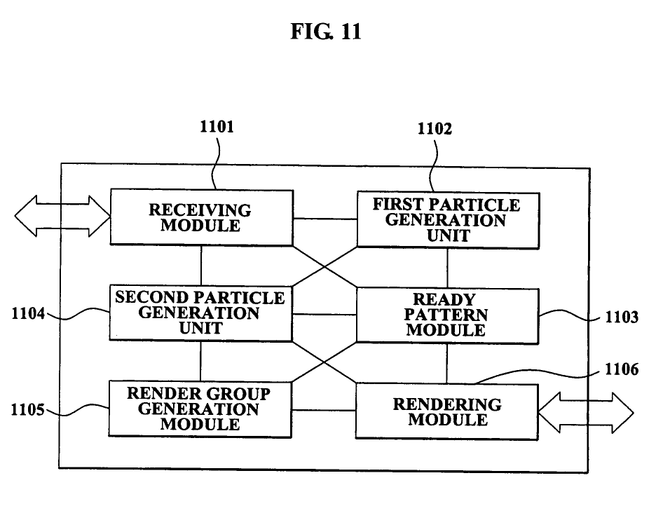

FIG. 11 is a block diagram illustrating a configuration of a particle rendering system according to an embodiment of the present invention. Referring to FIG. 11, the particle rendering system includes a receiving module 1101, a first particle generation unit 1102, a ready pattern module 1103, a second particle generation unit 1104, a render group generation unit 1105, and a rendering module 1106.

The receiving module 1101 receives a selection on a shape or a motion of a particle and/or a selection of a particle pattern from a user. In this instance, the shape selection is a selection with respect to at least one of a type, a rotation angle, an external appearance, a color, and a transparency of the particle, but not limited thereto. Also, the motion selection is a selection with respect to at least one of a duration time, a location, a speed, and an acceleration of the particle, but not limited thereto.

The first particle generation unit 1102 generates a first particle 606 corresponding to the shape or the motion by calling information corresponding to the shape selection from a shape information module 502 and/or information corresponding to the motion selection from a motion information module 503.

The ready pattern module 1103 stores a plurality of predetermined particle pattern information. In this instance, the particle pattern information includes information on a shape and a motion of a particle 605 and 606, as described above.

The second particle generation unit 1104 generates a second particle 605 by calling particle pattern information corresponding to a particle pattern selection from the ready pattern module 1103 and changing a shape or a motion of the called particle pattern information into the shape corresponding to the shape selection or the motion corresponding to the motion selection. The generated first particle 606 or second particle 605 is stored in a storage unit (not shown).

The render group generation module 1105 generates a render group 904 by sorting particles 605 and 606 stored in the storage unit or the ready pattern module according to a category. In this instance, the category may be information on at least one of a texture, an opacity and a material of the particle, as described above. Also, the render group generation module 1105 generates a particle set 801, 802, and 803 including a plurality of particles 605 and 606 that are stored in the storage unit or the ready pattern module 1103, sorts the particle set 801, 802, and 803 according to a category, and generates a render group 904 therefrom.

The rendering module 1106 calls a particle 605 and 606 included in the render group 904 and renders the called particle when receiving a rendering selection on the render group 904. In this instance, the rendering module 1106 may sort the particle sets 801, 802, and 803 included in the render group 904 in a sequence according to a distance from a reference point and generate a mesh therefrom before calling and rendering the mesh.

According to aspects of the present invention, there is provided a particle rendering method and system in which a user can easily generate a desired particle only by simply selecting shape information or motion information that are pre-generated and maintained. Also, according to aspects of the present invention, there is provided a particle rendering method and system in which a user can easily correct and change a shape and a motion of a predetermined particle pattern and then render the predetermined particle. Furthermore, according to aspects of the present invention, there is provided a particle rendering method and system that can render even a large number of particles in real time by sorting particles having a similar property into render groups and rendering particles for each render group.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A system to render and to provide particles, the system comprising:
a receiving module to receive a shape selection and/or a motion selection of a particle;
a shape information module to store pre-generated shape information;
a motion information module to store pre-generated motion information; and
a first particle generation unit to generate a first particle corresponding to the shape selection and/or the motion selection by calling shape information, of the pre-generated shape information, corresponding to the shape selection from the shape information module and/or motion information, of the pre-generated motion information, corresponding to the motion selection from the motion information module.

2. The system as claimed in claim 1, further comprising:
a ready pattern module to store a plurality of predetermined particle pattern information, such that each of the plurality of predetermined particle pattern information comprises predetermined shape information and/or predetermined motion information; and
a second particle generation unit to generate a second particle by:
calling a particle pattern information corresponding to a particle pattern selection from the ready pattern module;
calling the shape information corresponding to the shape selection from the shape information module and/or the motion information corresponding to the motion selection from the motion information module; and
changing the predetermined shape information and/or the predetermined motion information of the called particle pattern information into the shape information corresponding to the shape selection and/or the motion information corresponding to the motion selection,
wherein the receiving module receives the particle pattern selection.

3. The system as claimed in claim 2, further comprising:
a storage unit to store the first particle and/or the second particle.

4. The system as claimed in claim 3, further comprising:
a render group generation module to generate a render group comprising a plurality of particles stored in the storage unit or the ready pattern module; and
a rendering module to call the render group and to render the plurality of particles when receiving a rendering selection for the render group.

5. The system as claimed in claim 4, wherein the render group generation module generates the render group by sorting the plurality of particles according to a category.

6. The system as claimed in claim 5, wherein the category is information on at least one of a texture, an opacity, and a material of the plurality of particles.

7. The system as claimed in claim 3, further comprising:
a render group generation module to generate particle sets, each comprising a plurality of particles stored in the storage unit or the ready pattern module, and to generate a render group comprising a plurality of the particle sets; and
a rendering module to call the render group and to render the plurality of particle sets when receiving a rendering selection for the render group.

8. The system as claimed in claim 7, wherein the render group generation module generates the render group by sorting the particle sets according to a category.

9. The system as claimed in claim 8, wherein the category is information on at least one of a texture, an opacity, and a material of the particle sets.

10. The system as claimed in claim 7, wherein the rendering module generates a mesh by sorting the plurality of particle sets comprised in the render group according to a distance order from a reference point, and renders the mesh by calling the render group.

11. The system as claimed in claim 4, wherein the rendering module generates a mesh by sorting the plurality of particles comprised in the render group according to a distance order from a reference point, and renders the mesh by calling the render group.

12. The system as claimed in claim 1, wherein:
the shape selection is a selection relating to at least one of a type, a rotation angle, an external appearance, a color and a transparency of the particle, and
the motion selection is a selection relating to at least one of a duration time, a location, a speed, and an acceleration of the particle.

13. The system as claimed in claim 1, wherein the first particle generation unit generates the first particle corresponding to the shape selection and/or the motion selection by only calling the shape information and/or the motion information.

14. A method of rendering and providing a particle, the method comprising:
receiving a shape selection and/or a motion selection of a particle; and
generating the particle corresponding to the shape selection and/or the motion selection by calling shape information corresponding to the shape selection from a shape information module storing pre-generated shape information and/or motion information corresponding to the motion selection from a motion information module storing pre-generated motion information.

15. The method as claimed in claim 14, further comprising:
maintaining a ready pattern module storing a plurality of predetermined particle pattern information, such that each of the particle pattern information comprises predetermined shape information and/or predetermined motion information; and
receiving a particle pattern selection,
wherein the generating of the particle comprises:
calling particle pattern information, corresponding to the particle pattern selection, from the ready pattern module;
calling the shape information corresponding to the shape selection from the shape information module and/or the motion information corresponding to the motion selection from the motion information module; and
changing the predetermined shape information and/or the predetermined motion information of the called particle pattern information into the shape information corresponding to the shape selection and/or the motion information corresponding to the motion selection.

16. The method as claimed in claim 14, further comprising:
storing the particle in a predetermined storage unit;
generating a render group comprising a plurality of particles, including the generated particle, stored in the predetermined storage unit or the ready pattern module; and
calling the render group and rendering the plurality of particles when receiving a rendering selection for the render group.

17. The method as claimed in claim 16, wherein the generating of the render group comprises:
generating the render group by sorting the plurality of particles according to a category.

18. The method as claimed in claim 14, further comprising:
storing the particle in a predetermined storage unit;
generating particle sets, each comprising a plurality of particles stored in the predetermined storage unit or the ready pattern module;
generating a render group comprising a plurality of the particle sets; and
calling the render group and rendering the plurality of particles.

19. The method as claimed in claim 18, wherein the generating of the render group comprises:
generating the render group by sorting the particle sets according to a category.

20. The method as claimed in claim 18, wherein the calling of the render group comprises:
generating a mesh by sorting the plurality of particles according to a distance order from a reference point; and
rendering the mesh by calling the render group.

21. The method as claimed in claim 15, further comprising:
storing the particle in a predetermined storage unit;
generating a render group comprising a plurality of particles, including the generated particle, stored in the predetermined storage unit or the ready pattern module; and
calling the render group and rendering the plurality of particles when receiving a rendering selection for the render group.

22. The method as claimed in claim 15, further comprising:
storing the particle in a predetermined storage unit;
generating particle sets, each comprising a plurality of particles stored in the predetermined storage unit or the ready pattern module;
generating a render group comprising a plurality of the particle sets; and
calling the render group and rendering the plurality of particles.

23. The method as claimed in claim 21, wherein the calling of the render group comprises:
generating a mesh by sorting the plurality of particles according to a distance order from a reference point; and
rendering the mesh by calling the render group.

24. The method as claimed in claim 14, wherein the generating of the particle comprises only calling the shape information corresponding and/or the motion information.

25. A computer readable recording medium encoded with the method of claim 14 implemented by a computer.
